(19) United States
(12) Patent Application Publication
(10) Pub. No.: US 2018/0048038 A1
(43) Pub. Date: Feb. 15, 2018

(54) THERMAL EXCHANGE PLATE ASSEMBLY FOR VEHICLE BATTERY

(71) Applicant: Ford Global Technologies, LLC, Dearborn, MI (US)

(72) Inventors: Evan Mascianica, Detroit, MI (US); Josef Dollison, Petersburg, MI (US); Jeremy Samborsky, Livonia, MI (US); Asif Iqbal, Macomb, MI (US)

(21) Appl. No.: 15/235,277

(22) Filed: Aug. 12, 2016

(51) Int. Cl. H01M 10/6556; H01M 10/625; H01M 10/6568; H01M 10/613

(52) U.S. Cl. CPC H01M 10/6556; H01M 10/613; H01M 10/625; H01M 10/6568; H01M 2220/20

(57) ABSTRACT

A battery assembly according to an exemplary aspect of the present disclosure includes, among other things, a plurality of battery cells and a thermal exchange plate assembly in contact with the plurality of battery cells. The thermal exchange plate assembly includes a wire mesh structure.

### BACKGROUND

This disclosure relates to a battery assembly for an electrified vehicle. The battery assembly has a thermal exchange plate assembly, which includes a wire mesh structure.

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on the internal combustion engine to propel the vehicle.

High voltage battery assemblies are employed to power the electric machines of electrified vehicles. The battery assemblies include battery arrays constructed of a plurality of battery cells. An enclosure assembly houses the battery arrays. A cold plate may be placed in contact with the battery cells to thermally manage the heat generated by the battery cells.

### SUMMARY

A battery assembly according to an exemplary aspect of the present disclosure includes, among other things, a plurality of battery cells and a thermal exchange plate assembly in contact with the plurality of battery cells. The thermal exchange plate assembly includes a wire mesh structure.

In a further non-limiting embodiment of the foregoing battery assembly, the wire mesh structure includes a first set of parallel wires spaced-apart from one another and a second set of parallel wires spaced-apart from one another. The first and second sets of wires are interwoven.

In a further non-limiting embodiment of any of the foregoing battery assemblies, the first and second sets of wires are metallic wires.

In a further non-limiting embodiment of any of the foregoing battery assemblies, the thermal exchange plate assembly further includes a first facesheet on a first side of the wire mesh structure and a second facesheet on a second side of the wire mesh structure opposite the first side.

In a further non-limiting embodiment of any of the foregoing battery assemblies, the first and second sets of wires are interwoven such that the wire mesh structure has a square orientation when viewed in a direction parallel to a plane of the first facesheet.

In a further non-limiting embodiment of any of the foregoing battery assemblies, the wire mesh structure is arranged such that each wire in the first set of wires has a respective longitudinal axes extending substantially perpendicular to a plane defined by the first facesheet, and such that each wire in the second set of wires has a respective longitudinal axis extending substantially parallel to the plane.

In a further non-limiting embodiment of any of the foregoing battery assemblies, the first and second sets of wires are interwoven such that the wire mesh structure has a square orientation when viewed in a direction perpendicular to a plane of the first facesheet.

In a further non-limiting embodiment of any of the foregoing battery assemblies, the wire mesh structure is oriented such that each wire in the first set of wires has a respective longitudinal axis extending substantially parallel to a plane defined by the first facesheet, and such that each wire in the second set of wires has a respective longitudinal axis extending both substantially parallel to the plane and substantially perpendicular to the longitudinal axes of the first set of wires.

In a further non-limiting embodiment of any of the foregoing battery assemblies, the first and second sets of wires are interwoven such that the wire mesh structure has a diamond orientation when viewed in a direction parallel to a plane of the first facesheet.

In a further non-limiting embodiment of any of the foregoing battery assemblies, the wire mesh structure is oriented such that each wire in the first set of wires has a respective longitudinal axis extending at a first acute angle relative to a plane defined by the first facesheet, and such that each wire in the second set of wires has a respective longitudinal axis extending at a second acute angle relative to the plane.

In a further non-limiting embodiment of any of the foregoing battery assemblies, the second acute angle is provided by reflecting the first acute angle about an axis perpendicular to the plane.

In a further non-limiting embodiment of any of the foregoing battery assemblies, a fluid flow path is provided between the first and second facesheets.

In a further non-limiting embodiment of any of the foregoing battery assemblies, the thermal exchange plate assembly includes a fluid inlet and a fluid outlet. The fluid inlet and the fluid outlet are fluidly coupled to the fluid flow path.

In a further non-limiting embodiment of any of the foregoing battery assemblies, the battery assembly further includes a housing enclosing the plurality of battery cells. The housing encloses the fluid flow path on a first side and a second side opposite the first side.

In a further non-limiting embodiment of any of the foregoing battery assemblies, the thermal exchange plate assembly is in contact with the plurality of battery cells by way of an intermediate thermally insulating material.

An assembly according to an exemplary aspect of the present disclosure includes, among other things, a first facesheet, a second facesheet, and a wire mesh structure provided between the first facesheet and the second facesheet.

In a further non-limiting embodiment of the foregoing assembly, the wire mesh structure includes a first set of parallel wires spaced-apart from one another and a second set of parallel wires spaced-apart from one another. The first and second sets of wires are interwoven.

In a further non-limiting embodiment of any of the foregoing assemblies, the first and second sets of wires are metallic wires.

A method of forming an assembly according to an exemplary aspect of the present disclosure includes, among other things, bonding a facesheet to a wire mesh structure.

In a further non-limiting embodiment of the foregoing assembly, the facesheet is bonded to the wire mesh structure using transient liquid phase (TLP) brazing.

### BRIEF DESCRIPTION OF THE DRAWINGS

FIG. 1 schematically illustrates an example electrified vehicle.

FIG. 2 schematically illustrates an example battery assembly.

FIG. 3 illustrates an example thermal exchange plate assembly.

FIG. 4A illustrates a first aspect of an example method of forming a thermal exchange plate assembly.

FIG. 4B illustrates a second aspect of the example method of forming the thermal exchange plate assembly.

FIG. 5A illustrates is a front view of a first orientation of a wire mesh structure of the thermal exchange plate assembly. In FIG. 5A, the wire mesh structure is provided in a diamond orientation.

FIG. 5B is a cross-sectional view taken along line 5B-5B from FIG. 5A.

FIG. 6A illustrates is a front view of a second orientation of a wire mesh structure of the thermal exchange plate assembly. In FIG. 6A, the wire mesh structure is provided in a first square orientation.

FIG. 6B is a cross-sectional view taken along line 6B-6B from FIG. 6A.

FIG. 7A illustrates is a front view of a third orientation of a wire mesh structure of the thermal exchange plate assembly. In FIG. 7A, the wire mesh structure is provided in a second square orientation.

FIG. 7B is a cross-sectional view taken along line 7B-7B from FIG. 7A.

### DETAILED DESCRIPTION

This disclosure relates to an assembly for an electrified vehicle. The assembly may be a battery assembly that includes a thermal exchange plate assembly for thermally managing heat generated by battery cells of the battery assembly. In one example, the thermal exchange plate assembly includes a wire mesh structure, which provides an increased surface area for heat transfer, and also distributes heat further away from the battery cells. These and other features are discussed in greater detail in the following paragraphs of this detailed description.

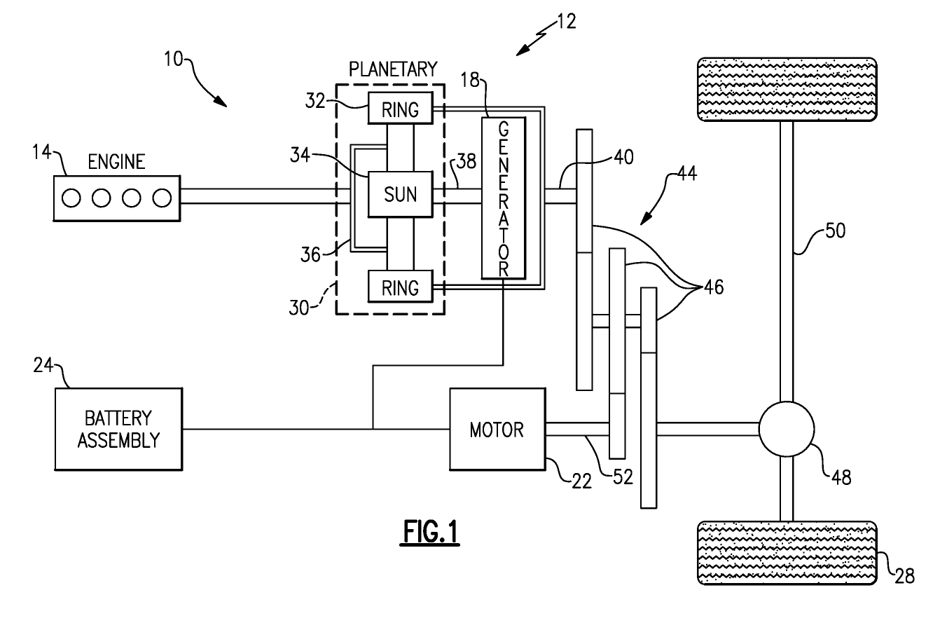

FIG. 1 schematically illustrates a powertrain 10 for an electrified vehicle 12. Although depicted as a hybrid electric vehicle (HEV), it should be understood that the concepts described herein are not limited to HEV's and could extend to other electrified vehicles, including, but not limited to, plug-in hybrid electric vehicles (PHEV's) and battery electric vehicles (BEV's).

In one embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery assembly 24. In this example, the second drive system is considered an electric drive system of the powertrain 10. The first and second drive systems generate torque to drive one or more sets of vehicle drive wheels 28 of the electrified vehicle 12. Although a power-split configuration is shown, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery assembly 24.

The battery assembly 24 is an example type of electrified vehicle battery. The battery assembly 24 may include a high voltage traction battery pack that includes a plurality of battery arrays, or groupings of battery cells, capable of outputting electrical power to operate the motor 22 and the generator 18. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery assembly 24 state of charge up to its maximum allowable discharging rate under certain driving patterns/cycles. The EV mode is an example of a charge depleting mode of operation for the electrified vehicle 12. During EV mode, the state of charge of the battery assembly 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery assembly 24 at a constant or approximately constant level by increasing the engine 14 propulsion usage. The electrified vehicle 12 may be operated in other operating modes in addition to the EV and HEV modes within the scope of this disclosure.

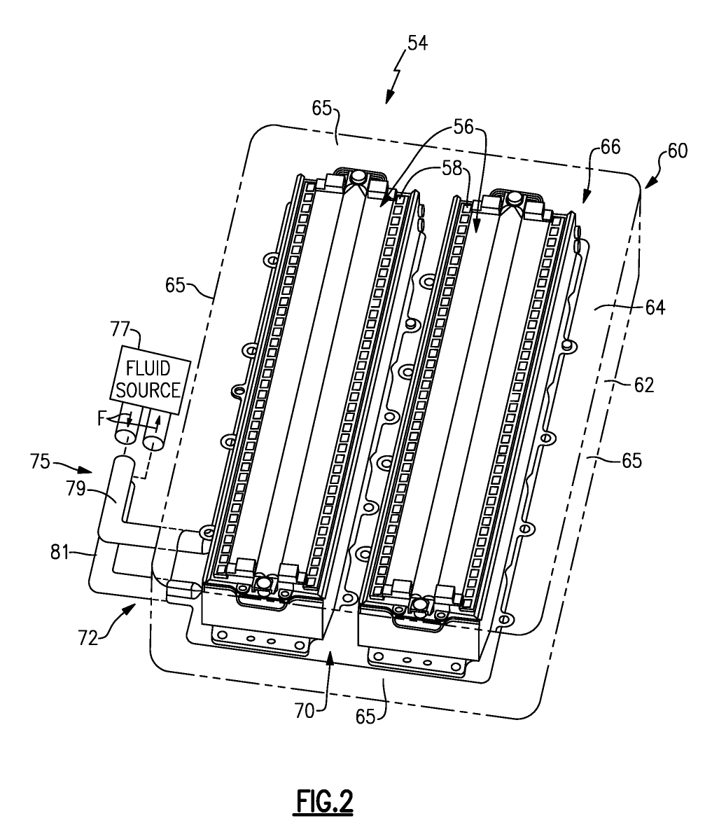

FIG. 2 illustrates a battery assembly 54 that can be incorporated into an electrified vehicle. For example, the battery assembly 54 could be employed within the electrified vehicle 12 of FIG. 1. The battery assembly 54 includes battery arrays 56, which can be described as groupings of battery cells, for supplying electrical power to various vehicle components. Although two battery arrays 56 are illustrated in FIG. 2, the battery assembly 54 could include a single battery array or multiple battery arrays within the scope of this disclosure. In other words, this disclosure is not limited to the specific configuration shown in FIG. 2.

Each battery array 56 includes a plurality of battery cells 58 that may be stacked side-by-side along a span length of each battery array 56. Although not shown in the highly schematic depiction of FIG. 2, the battery cells 58 are electrically connected to one another using busbar assemblies. In one embodiment, the battery cells 58 are prismatic, lithium-ion cells. However, battery cells having other geometries (cylindrical, pouch, etc.) and/or other chemistries (nickel-metal hydride, lead-acid, etc.) could alternatively be utilized within the scope of this disclosure.

An enclosure assembly 60 (shown in phantom in FIG. 2) surrounds the battery arrays 56. The enclosure assembly 60 defines an interior 66 for housing the battery arrays 56 and, potentially, any other components of the battery assembly 54. In one non-limiting embodiment, the enclosure assembly 60 includes a tray 62 and a cover 64 which establish a plurality of walls 65 that surround the interior 66. The enclosure assembly 60 may take any size, shape or configuration, and is not limited to the specific configuration of FIG. 2.

During some conditions, heat may be generated by the battery cells 58 of the battery arrays 56 during charging and discharging operations. Heat may also be transferred into the battery cells 58 during vehicle key-off conditions as a result of relatively hot ambient conditions. During other conditions, such as relatively cold ambient conditions, the battery cells 58 may need heated. A thermal management system 75 may therefore be utilized to thermally condition (i.e., heat or cool) the battery cells 58.

The thermal management system 75, for example, may include a fluid source 77, an inlet 79, an outlet 81, and a thermal exchange plate assembly 70. The thermal exchange plate assembly 70 may, in some examples, be referred to as a cold plate assembly. In one embodiment, the inlet 79 and the outlet 81 fluidly couple the fluid source 77 to the thermal exchange plate assembly 70 and may include tubes, hoses, pipes or the like. A fluid F, such as glycol or some other suitable fluid, is communicated from the fluid source 77 to the inlet 79, through tubing 72 of the thermal exchange plate assembly 70, and then through the thermal exchange plate assembly 70. The fluid F is circulated through the thermal exchange plate assembly 70, which is in contact with one or more surfaces of the battery cells 58, to either add or remove heat to/from the battery assembly 54. In other words, the fluid F may enhance the heat transfer effect achieved by the thermal exchange plate assembly 70. The fluid F may then be discharged through the tubing 72 into the outlet 81 before returning to the fluid source 77.

In one example, there are two arrays of battery cells 58. In that example, the fluid F may flow from the fluid source 77, through a portion of the thermal exchange plate assembly 70 corresponding a first array, and then flow in series to the portion of the thermal exchange plate assembly 70 corresponding to the second array before returning to the outlet 81. In another example, the fluid flows from the inlet 79 and flows in parallel through the portions of the thermal exchange plate assembly 70 corresponding to the first and second arrays before returning to the outlet 81.

Because the fluid F can either take on heat from the battery cells 58 or give off heat to the battery cells 58, the fluid F exiting through the outlet 81 can have a different temperature than the fluid F entering through the inlet 79. In one non-limiting embodiment, the battery arrays 56 of the battery assembly 54 are positioned atop the thermal exchange plate assembly 70 so that the thermal exchange plate assembly 70 is in contact with a bottom surface of each battery cell 58.

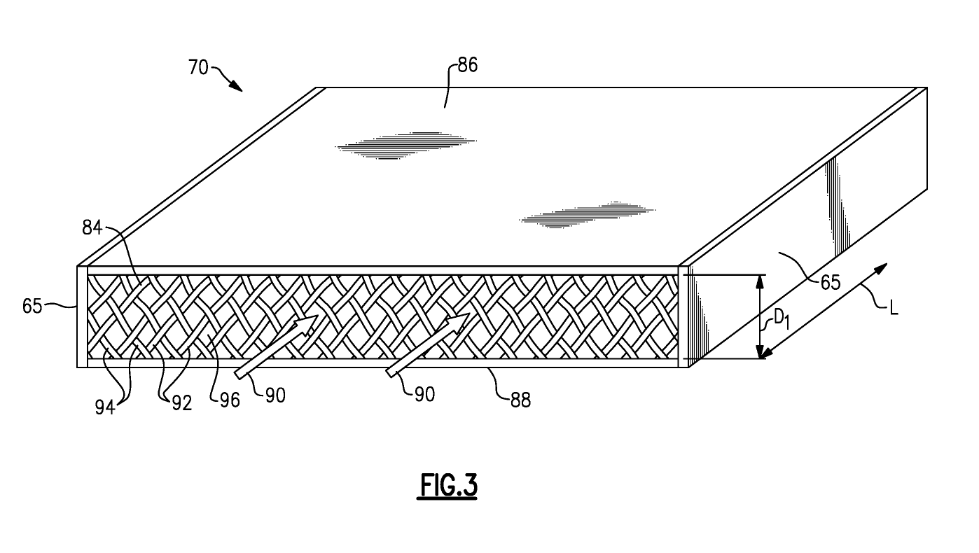

FIG. 3 illustrates an example thermal exchange plate assembly 70. In FIG. 3, the thermal exchange plate assembly 70 includes a wire mesh structure 84, which facilitates an exchange of thermal energy between the battery cells 58 and the thermal exchange plate assembly 70. Fluid F flowing through the thermal exchange plate assembly 70 flows through the mesh structure 84. In particular, the fluid F flows over the wires of the wire mesh structure 84.

In this example, the wire mesh structure 84 is provided between first and second facesheets 86, 88 of the thermal exchange plate assembly 70. The first facesheet 86 is a top facesheet in this example, and is in contact with a bottom of the battery cells 58. In one example, the first facesheet 86 is in contact with the bottom of the battery cells 58 by way of an intermediate layer of a thermally insulating material. The second facesheet 88 is a bottom facesheet and is provided on an opposite side of the wire mesh structure 84 of the first facesheet 86. The first and second facesheets 86, 88 provide upper and lower boundaries for a fluid flow path 90. The fluid flow path 90 is also bounded on the sides by the walls 65 of the enclosure assembly 60. Alternatively, the sides of the fluid flow path 90 could be bounded by dedicated walls separate from the walls 65 of the enclosure assembly 60.

In this example, the wire mesh structure 84 spans the entire distance D₁ between the first and second facesheets 86, 88, which distributes heat away from the first facesheet 86, and in turn the battery cells 58. The wire mesh structure 84 also provides an increased surface area for the fluid F to interact with as it flows through the wire mesh structure 84 along the flow path 90. Further, the wire mesh structure 84 creates turbulence in the fluid F as the fluid F flows along the flow path 90, which also increases heat transfer. Thus, the wire mesh structure 84 provides effective and efficient heat transfer.

In this example, the wire mesh structure 84 includes a first set of parallel wires 92 spaced-apart from one another and a second set of parallel wires 94, which are also spaced-apart from one another. The first and second sets of parallel wires 92, 94 are interwoven such that they crisscross and overlap one another in an alternating arrangement, and are spaced-apart from one another to provide gaps 96 which allow fluid F to flow over the wires 92, 94 while flowing along the fluid flow path 90.

The first and second sets of wires 92, 94 are metallic wires, such as copper wires, in this example. This disclosure is not limited to wire mesh structures having copper wires, however, and extends to other types of materials.

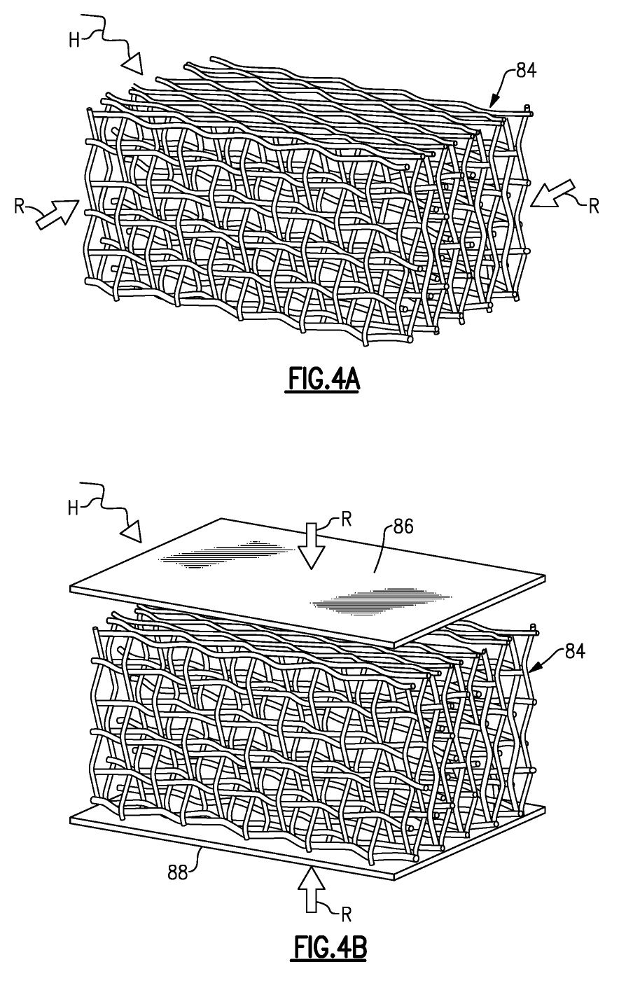

With reference to FIG. 4A, in one example the wire mesh structure 84 is initially formed using a bonding technique, such as transient liquid phase (TLP) brazing. In particular, a sintering agent is applied to the wire mesh structure, and heat H and pressure R are further applied to bond the wire mesh structure 84 together. With reference to FIG. 4B, the facesheets 86, 88 are then applied to the wire mesh structure 84 using a bonding technique such as TLP brazing. In this example, pressure R is applied to the facesheets 86, 88 and heat H is applied to the overall thermal exchange plate assembly 70. While TLP brazing is shown and described herein relative to FIGS. 4A-4B, this disclosure extends to other methods of forming the wire mesh structure 84.

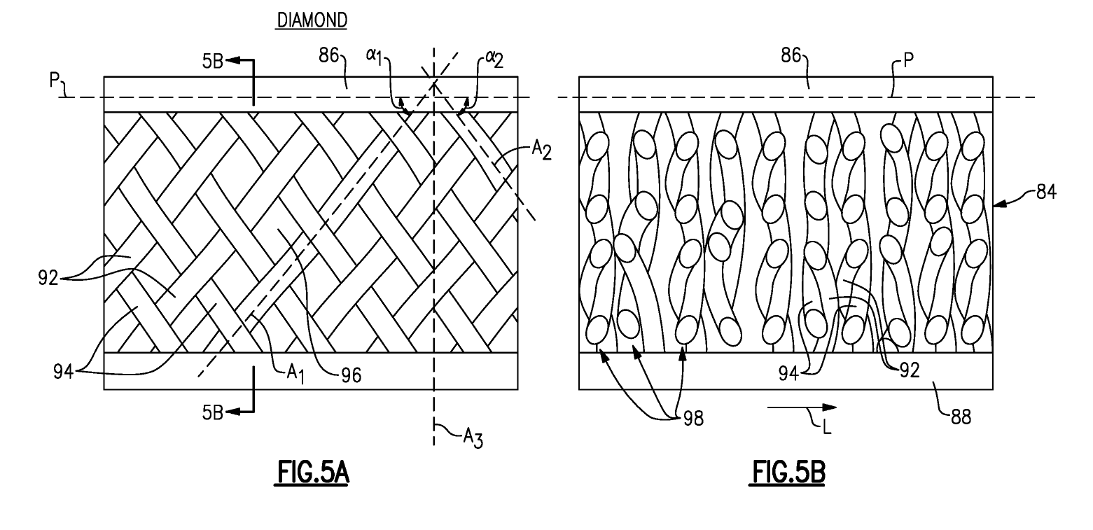

FIGS. 5A-7B illustrate three example wire mesh structure 84 orientations. While three orientations are illustrated, this disclosure extends to other orientations. With reference to FIGS. 5A-5B, a first example orientation is a “diamond” orientation. In this orientation, the wire mesh structure 84 provides a plurality of diamond-shaped gaps 96 when viewed in a direction parallel to a plane P of the first facesheet 86. Reference herein is made to the plane P of the first facesheet 86 for purposes of explanation only. The wire mesh structure 84 also provides diamond-shaped gaps 96 when viewed along the flow path 90, when viewed in a direction perpendicular to the distance D₁, etc.

With continued reference to FIGS. 5A-5B, each of the wires in the first set of wires 92 has a respective longitudinal axis A₁ extending at a first acute angle α₁ relative to the P, and each of the wires in the second set of wires 94 has a respective longitudinal axis A₂ extending at a second acute angle α₂ relative to the plane P. In this example, the second acute angle α₂ is provided by reflecting the first acute angle α₁ about an axis A₃ perpendicular to the plane P.

As shown in FIG. 5B, the wire mesh structure 84 includes a plurality of stacks 98 extending along the length L of the thermal exchange plate assembly 70. In this example, each stack 98 is provided by interweaving a plurality of the first wires 92 with a plurality of the second wires 94. The length L in this example is parallel to the flow path 90 and perpendicular to the distance D₁.

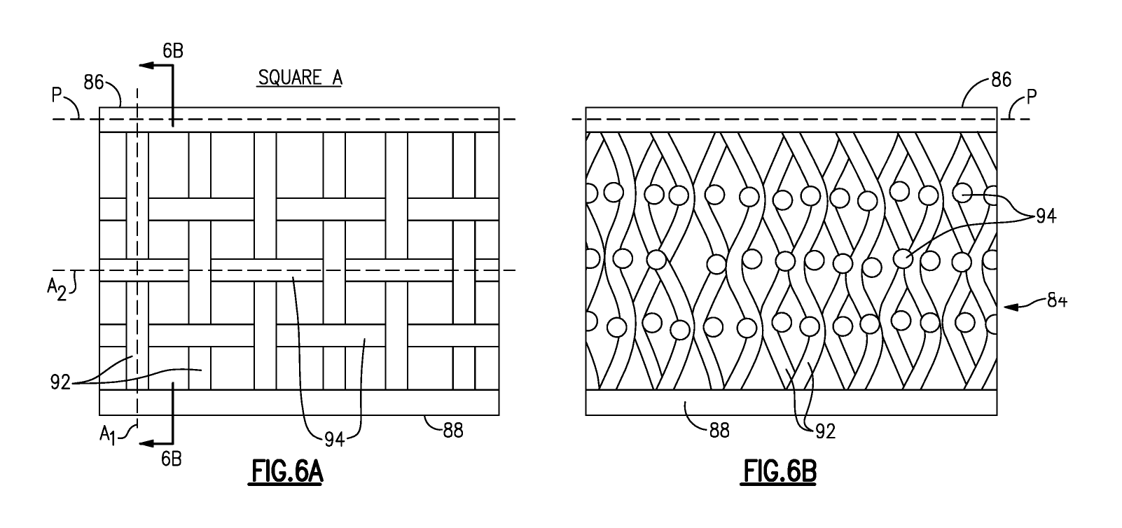

FIGS. 6A-6B illustrate a second example orientation of the wire mesh structure 84. In this example, the wire mesh structure 84 provides a “square” orientation (labeled as “Square A” in FIG. 6A), in which the first and second sets of wires 92, 94 are interwoven to provide a plurality of square-shaped gaps 96 when viewed parallel to the plane P. In particular, in this example, the wire mesh structure 84 is arranged such that each of wires in the first set of wires 92 has a respective longitudinal axis A₁ extending substantially perpendicular to the plane P. Further, each of the wires in the second set of wires 94 has a respective longitudinal axis A₂ extending substantially parallel to the plane P and perpendicular to the longitudinal axes A₁ of the first set of wires 92.

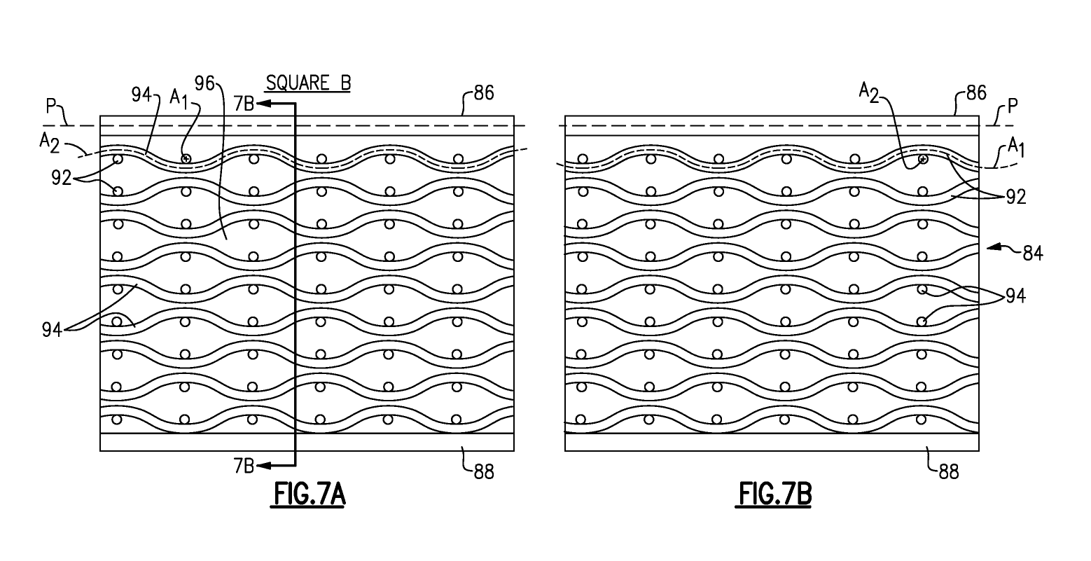

FIGS. 7A-7B illustrates the wire mesh structure 84 in a third example orientation. In this orientation, the wire mesh structure 84 has a square orientation when viewed in a direction perpendicular to the plane P (labeled as “Square B” in FIG. 7A). The first and second sets of wires 92, 94 are arranged similar to the example of FIGS. 6A-6B, except the wires 92, 94 are oriented such that the square-shaped gaps face the first and second facesheets 86, 88. In particular, each of the wires in the first set of wires 92 has a respective longitudinal axis A₁ extending substantially parallel to the plane P (e.g., into the page, relative to FIG. 7A), and such that each of the wires in the second set of wires 94 has a respective longitudinal axis A₂ extending both substantially parallel to the plane P and substantially perpendicular to the longitudinal axes A₁. In this example, the wire mesh structure 84 also provides a plurality of gaps 96 for fluid to flow through.

It should be understood that terms such as “top,” “bottom,” “side,” etc., are used above with reference to the normal operational orientation of the battery assembly. Further, these terms have been used herein for purposes of explanation, and should not be considered otherwise limiting. Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery assembly, comprising:
a plurality of battery cells; and
a thermal exchange plate assembly in contact with the plurality of battery cells, wherein the thermal exchange plate assembly includes a wire mesh structure.

2. The battery assembly as recited in claim 1, wherein the wire mesh structure includes a first set of parallel wires spaced-apart from one another and a second set of parallel wires spaced-apart from one another, wherein the first and second sets of wires are interwoven.

3. The battery assembly as recited in claim 2, wherein the first and second sets of wires are metallic wires.

4. The battery assembly as recited in claim 2, wherein the thermal exchange plate assembly further includes a first facesheet on a first side of the wire mesh structure and a second facesheet on a second side of the wire mesh structure opposite the first side.

5. The battery assembly as recited in claim 4, wherein the first and second sets of wires are interwoven such that the wire mesh structure has a square orientation when viewed in a direction parallel to a plane of the first facesheet.

6. The battery assembly as recited in claim 5, wherein the wire mesh structure is arranged such that each wire in the first set of wires has a respective longitudinal axes extending substantially perpendicular to a plane defined by the first facesheet, and such that each wire in the second set of wires has a respective longitudinal axis extending substantially parallel to the plane.

7. The battery assembly as recited in claim 4, wherein the first and second sets of wires are interwoven such that the wire mesh structure has a square orientation when viewed in a direction perpendicular to a plane of the first facesheet.

8. The battery assembly as recited in claim 7, wherein the wire mesh structure is oriented such that each wire in the first set of wires has a respective longitudinal axis extending substantially parallel to a plane defined by the first facesheet, and such that each wire in the second set of wires has a respective longitudinal axis extending both substantially parallel to the plane and substantially perpendicular to the longitudinal axes of the first set of wires.

9. The battery assembly as recited in claim 4, wherein the first and second sets of wires are interwoven such that the wire mesh structure has a diamond orientation when viewed in a direction parallel to a plane of the first facesheet.

10. The battery assembly as recited in claim 9, wherein the wire mesh structure is oriented such that each wire in the first set of wires has a respective longitudinal axis extending at a first acute angle relative to a plane defined by the first facesheet, and such that each wire in the second set of wires has a respective longitudinal axis extending at a second acute angle relative to the plane.

11. The battery assembly as recited in claim 10, wherein the second acute angle is provided by reflecting the first acute angle about an axis perpendicular to the plane.

12. The battery assembly as recited in claim 4, wherein a fluid flow path is provided between the first and second facesheets.

13. The battery assembly as recited in claim 12, wherein the thermal exchange plate assembly includes a fluid inlet and a fluid outlet, wherein the fluid inlet and the fluid outlet are fluidly coupled to the fluid flow path.

14. The battery assembly as recited in claim 13, further comprising a housing enclosing the plurality of battery cells, wherein the housing encloses the fluid flow path on a first side and a second side opposite the first side.

15. The battery assembly as recited in claim 1, wherein the thermal exchange plate assembly is in contact with the plurality of battery cells by way of an intermediate thermally insulating material.

16. An assembly, comprising:
a first facesheet;
a second facesheet; and
a wire mesh structure provided between the first facesheet and the second facesheet.

17. The assembly as recited in claim 16, wherein the wire mesh structure includes a first set of parallel wires spaced-apart from one another and a second set of parallel wires spaced-apart from one another, wherein the first and second sets of wires are interwoven.

18. The assembly as recited in claim 17, wherein the first and second sets of wires are metallic wires.

19. A method of an assembly, comprising:
bonding a facesheet to a wire mesh structure.

20. The method as recited in claim 19, wherein the facesheet is bonded to the wire mesh structure using transient liquid phase (TLP) brazing.
